(19) United States
(12) Patent Application Publication
(10) Pub. No.: US 2019/0137611 A1
(43) Pub. Date: May 9, 2019

(54) SCANNING OPTICAL BEAM SOURCE

(71) Applicant: Innovative Micro Technology, Goleta, CA (US)

(72) Inventor: Christopher S. GUDEMAN, Lompoc, CA (US)

(73) Assignee: Innovative Micro Technology, Goleta, CA (US)

(21) Appl. No.: 16/164,802

(22) Filed: Oct. 19, 2018

Related U.S. Application Data
(60) Provisional application No. 62/581,638, filed on Nov. 3, 2017.

(51) Int. Cl. G01S 7/481; G02B 27/09; G01S 17/89; G01S 17/42

(52) U.S. Cl. CPC G01S 7/4817; G02B 27/0922; G02B 27/0961; G02B 27/0944; G01S 17/89; G01S 17/42; G02B 27/095; G01S 7/4815

(57) ABSTRACT

We describe here a scanning optical beam that is comprised of no moving parts The device includes a plurality of microfabricated beam shaping elements disposed in an array wherein each microfabricated beam shaping element is registered with a microfabricated light source but has an optical axis that is offset from the optical axis of the light source by a different amount, wherein the amount is a function of the distance from a center of the arrays. A method of operating the scanning optical beam is also described.

### CROSS REFERENCE TO RELATED APPLICATIONS

This US patent application claims priority to Provisional U.S. Patent Application Ser. No. 62/581,638, filed Nov. 3, 2017, which is incorporated by reference in its entirety.

### STATEMENT REGARDING FEDERALLY SPONSORED RESEARCH

Not applicable.

### STATEMENT REGARDING MICROFICHE APPENDIX

Not applicable.

### BACKGROUND

This invention relates to a system for controlling illumination from a plurality of light sources electronically.

Tracking the presence and motion of objects has historically been done using human vision, still and video imaging, and radar technology. Human vision works well for distances up to the visual horizon, but human factors such as the age, sleepiness, distractions, and intoxication impose severe and unpredictable limitations. Also, data acquired using human vision is difficult to rapidly convert into data usable by a machine.

Video imaging, both still and moving frames, overcomes many of the shortcomings of human vision. However, image data packets (frames) consume vast amounts of computer storage and computation resources, including RAM, hard drives, ultra-fast analog-to-digital converters (ADCs), and highly parallel processors, thus limiting the timeliness of the wealth of data that can be available. For gesture recognition, automobile guidance, avionics and explosive projectile interception, the acquisition and processing of video frames is still too slow. The data problem is elegantly addressed by radar technology, but cost, weight and power limit its broad employment.

A cost effective approach that is quite similar to radar is LIDAR, which uses reflected light from a scanning optical beam, as opposed to radar, which tracks reflected radio frequency (RF) energy from a scanning RF beam.

LIDAR is a fairly new technology. Much of the current work focuses on scanning mirrors to create a scanning beam of light, which is often generated by a bulky laser. These mirrors can also be bulky and also generally have poor reliability because they must move rapidly and precisely. Protecting the mirror is expensive and adds to the size and weight of the final device. These problems have limited the application of LIDAR technology to a few areas, including high-resolution mapping, such as for agricultural and geological purposes, control and navigation for some autonomous cars. Smaller, more robust, less costly systems may achieve wider acceptance and widespread application in range-finding and imaging.

Accordingly, a compact, robust and inexpensive optical structure would enable far more applications for LIDAR.

### SUMMARY

Described here is a structure, method of use, and manufacturing process that overcomes these problems, to render a robust and inexpensive LIDAR-like rangefinder.

We describe here a scanning optical beam device that uses no moving parts. Thus, it is very reliable, has very low mass, and is very small.

The system may make use of a scanning optical beam source, including a plurality of microfabricated light sources disposed in a first array having an array center and disposed on a first substrate. The device also may have a plurality of microfabricated beam shaping elements disposed in a second array disposed on a second substrate having the same array center, wherein each microfabricated beam shaping element is registered with a microfabricated light source but has an optical axis that is offset from the optical axis of the light source by an amount. This amount of offset may be a function of the distance from a center of the arrays. In a simple case, the function may be linear, so the amount of offset is directly proportional to the distance from the center of the array. However, other functions are also possible, for example a quadratic function. In this case, the offset is the square of the distance from the center. Many other functions are also possible, such as hyperbolic or exponential.

The method of using this system may include energizing the plurality of light sources sequentially across each row and sequentially down each column, so that an image cast by the plurality of microfabricated sources is raster scanned. The method may also include emitting radiation from at least one of the plurality of light sources, reflecting the radiation from at least one of the plurality of light sources on the target reflective surface, detecting the reflected light with a detector, and measuring the time elapsed from emission to detection.

### BRIEF DESCRIPTION OF THE DRAWINGS

Various exemplary details are described with reference to the following figures, wherein:

FIG. 1 is a cross sectional diagram of an embodiment of an scanning optical beam source using VCSELs and a plurality of beam shaping elements, here a chirped grating;

FIG. 2a is a plan view diagram of an embodiment of an scanning optical beam source using an array of Fresnel lenses; FIG. 2b is a cross sectional diagram of an embodiment of an scanning optical beam source using an array of Fresnel lenses;

FIG. 3a is a plan view diagram of an embodiment of an scanning optical beam source using an array of ball lenses; FIG. 3b is a cross sectional diagram of an embodiment of an scanning optical beam source using an array of ball lenses;

FIG. 4a is a cross sectional diagram showing the diverging pattern of the radiation from the plurality of light sources; FIG. 4b shows the effect of the offset arrangement of optical axes;

FIG. 5 is a cross sectional diagram of an scanning optical beam source with an adjacent detector;

FIG. 6 is a cross sectional diagram of one embodiment of the scanning optical beam source; and

FIG. 7 is a cross sectional diagram of another embodiment of the scanning optical beam source.

It should be understood that the drawings are not necessarily to scale, and that like numbers may refer to like features.

### DETAILED DESCRIPTION

We describe below a system and method for fabricating a scanning optical beam source. The source is comprised of no moving parts, and is thus exceptionally reliable, very low mass, and very small.

This device may include an array of light sources. Vertical Cavity Surface Emitting Lasers (VCSELs) may be used, but other light sources such as edge emitting semiconductor lasers and super-luminescent LEDs may also be suitable. The systems and methods will be described with respect to a VCSEL embodiment. However, it should be understood that the VCSEL is but one embodiment, and that the systems and methods may be applied to a variety of small or microscopic light sources. The array of light sources may include a set of horizontal rows and vertical columns, and there may be about 10 to about 100 light sources in each row and column.

An array of VCSELs can be manufactured monolithically on a single substrate at very low cost. Arrays of 10×10 can be as small as 1 mm×1 mm. The divergence angle of these VCSELs is roughly 20 degrees (full width at 1/e²), which greatly limits the operating range of the object tracking. Thus a lens is generally employed such that the focal plane of the lens is placed at the lasing surface. Similarly, an array of lenses can be manufactured by micro-fabrication on a second substrate at very low cost. Each lens in the lens array can provide collimation for each VCSEL in the VCSEL array, resulting in a very low cost and manufacturable device. These lenses can be spherical ball lenses, spheres, Fresnel lenses or lithographically fabricated refractive elements, for example.

Accordingly, the device may also comprise an array of beam shaping elements, which bend rays of light in a certain directions. Lenses are a simple example of a beam shaping element, but they may also include gratings, prisms and reflective surfaces. If a light source is placed at the focal distance of the lens, the diverging rays of the light sources may be collimated by the lens.

In the following description, the following reference numbers refer to the following features of the system. Like numbers may refer to like features in the various embodiments.
10, 100 VCSEL substrate
20, 120 VCSELs
30, 300 transparent wafer
40 microlenses
110 chirped grating
140 ball lens
150 illuminated plane
160 detector
180 reflective surface
190 controller
330 beam shaping lens
500 interposer substrate

If the pitch of the VCSEL array is systematically slightly smaller than that of the lens array, and if the lens array is centered on the VCSEL array, the light from the center VCSELs will propagate essentially normal to the plane. The propagation direction for VCSELs further from the center will deviate from the normal by an angle that is roughly proportional to the distance from the center. If the VCSELs are turned on one at a time, the beam emanating from the array will appear to raster, painting an area that is proportional to the distance from the array. A higher density of VCSELs with a small offset in pitch between VCSEL and lens array, will produce a painted frame with a higher pixel resolution. A larger pitch offset will create a larger frame at a given distance. Thus, the frame size and resolution can be customized for the particular application.

If the light from each VCSEL element can be pulsed on, the distance to the object can be determined by the timing of the optical reflection. Note that the speed of light is approximately 1 foot/nanosecond. To enable such a measurement, this electrically steerable light source is used in a system that also uses a sensitive optical detector. For a tracked object that is 30 feet from the source, the optical echo will arrive at the detector approximately 60 nsec after the VCSEL pulse. If we provide a 100 nsec time window for each VCSEL, a 100 element array can fully interrogate the frame in 10 usec, thus providing an extremely high frame rate. Compared to a typical video frame duration of 16 msec, using this method offers an improvement of 1000×. This detector can employ an optical wavelength filter that passes only the wavelength of the VCSEL, thus greatly improving signal-to-noise ratio (S/N).

Modulation methods, such as frequency modulation, can also be applied to improve depth resolution and enhance velocity sensing. There are several other emerging LIDAR implementations and virtually all of them may employ the VCSEL/Lens array system disclosed here. A controller may be used, which is configured to pulse the plurality of light sources serially, and measures the elapsed time from the pulse to the detection of the reflected radiation. The controller may be configured to pulse the plurality of light sources serially, and to measure the elapsed time from the pulse to the detection of the reflected radiation. The controller may also generate an image showing the locations of the reflective surfaces relative to one another and relative to the array center.

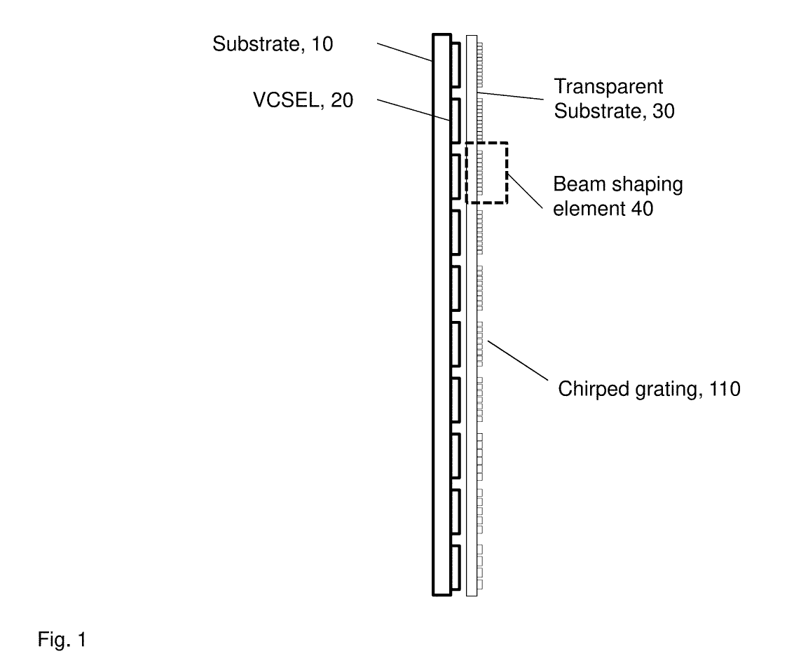

FIG. 1 is a cross sectional diagram of an embodiment of a scanning optical beam source using VCSELs and an array of beam shaping elements 40. In this example, the beam shaping elements 40 may be an array of chirped gratings 110. In FIG. 1, a substrate 10 may be a silicon substrate or a III-V material, and there may be a plurality of light sources 20 disposed thereon. The plurality of light sources 20 may be vertical cavity surface emitting lasers (VCSELs) for example, or edge emitting semiconductor lasers or super-luminescent LEDs, for example. In any case, the light sources may emit radiation into some solid angle, diverging from the sources 20. This diverging light may be shaped by a beam shaping element 40, an example of which is the grating 110 shown in FIG. 1. The beam shaping elements 40 may be fabricated in a second substrate 30, or the beam shaping elements 40 may be placed and adhered on the second substrate 30. The second substrate 30 may be transparent to the emitted radiation from sources 20.

The beam shaping elements 40 may be any of a number of light-bending objects. The chirped grating 110, for example, shown in FIG. 1, which may be a set of grooves with a variable pitch between the grooves. The grating may therefore scatter light by an amount which depends on which portion of the grating is illuminated by the light. By offsetting the grating 110 from the light source 20, the diffraction angle may vary across the array, and thus light emitted by a light source in the periphery of the array may be scattered at a wider angle than light emitted by a source at the center of the array.

The term “array center” should be understood to mean the geometric center of the plurality of discrete elements, be they light sources or beam shaping elements. The terms “wafer” and “substrate” are used interchangeably herein, to refer to a flat, generally circular supporting material upon which structures may be microfabricated, such as integrated circuits and microelectromechanical systems (MEMS) structures. The “optical axis” of an optical element is a term usually applied to elements with rotational symmetry, such as a lens. The optical axis may be a line along which there is some rotational symmetry and defines the path along which light propagates through the system with minimal deflection. The optical axis generally passes through the center of curvature of each surface, and coincides with the axis of rotational symmetry.

The chirped grating is an example of a beam shaping element 40, of which several different sorts are discussed herein. Other beam shaping elements include refractive surfaces, lenses such as ball lenses, Fresnel lenses, gratings and the like. It should be understood that the scope of this invention includes any such beam shaping elements.

In one embodiment, the beam shaping elements are fabricated directly in the transparent substrate 30. The beam shaping elements 40 may be a plurality of refractive surfaces such as used in Fresnel lens, or the beam shaping element may be a single refractive surface as with a lens surface. The surface may refract the light due to the refractive index of the transparent material, the shape of the refractive surface and the angle of incidence of the emitted radiation against the refractive surface of the beam shaping element 30.

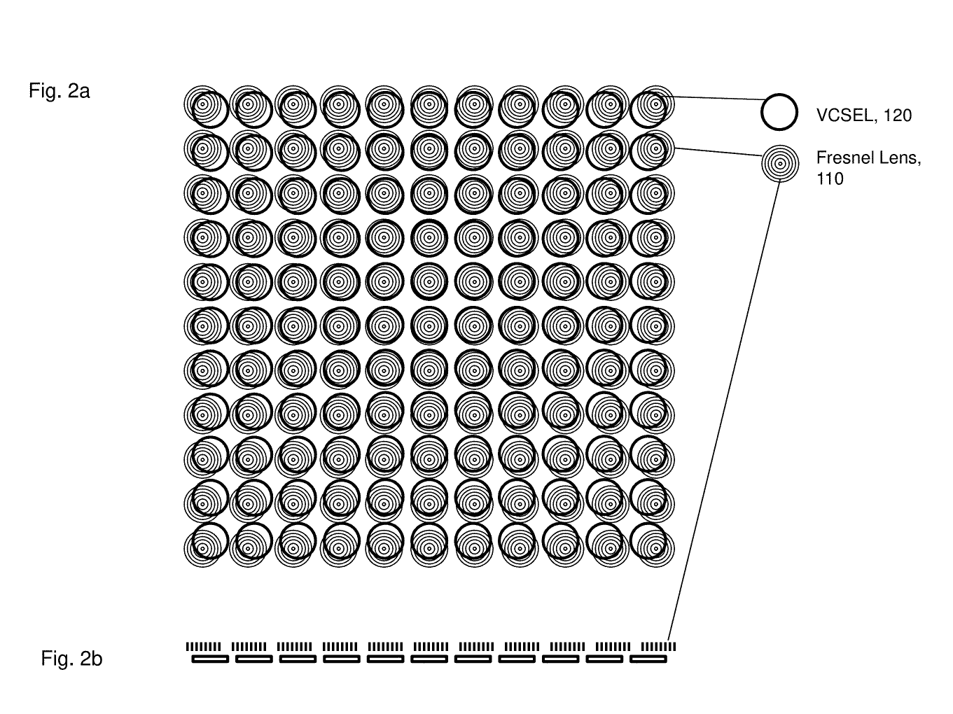

One beam shaping element 40, a lens 140 for example, can affect the beam propagation of a light source in several ways. If the optical axis of the lens is placed on the axis of emission of the light source, it will create an image of the light source that lies on the axis of emission. The location of the image along the axis of emission can be varied by moving the lens on this axis. If the lens is moved off axis, the image of the light source will move off axis as well. Thus if an array of lenses is placed in proximity with an array of light sources such that emission from each source is launched into a respective lens, a systematic off axis offset of each lens position will create an array of beams of light that fan out systematically. For LIDAR applications the image of the emission source is ideally collimated. A collimated beam is created when the emission source is placed at the focal point of its respective lens. In this case the image of the light source is at infinity. FIGS. 2a and 2b show the ball lens embodiment in plan view and cross section.

FIG. 2a is a plan view diagram of an embodiment of a scanning optical beam source using an array of Fresnel lenses, wherein the optical axis of the microfabricated Fresnel lenses are offset from the optical axis of the VCSEL. The amount of offset may be proportional to the distance from the center of the array. The outermost rows and columns have beam shaping elements that are offset most severely from the optical axis of the sources. FIGS. 2a and 2b show the Fresnel lens embodiment in plan view and cross section, respectively.

A Fresnel lens is an optical element that divides the continuous surface of a standard lens into a set of surfaces of the same curvature, with stepwise discontinuities between them. Fresnel lenses may substantially reduce the size, cost and weight of a lens by dividing the lens into a set of concentric annular sections. An ideal Fresnel lens would have an infinite number of sections. In each section, the overall thickness is decreased compared to an equivalent simple lens. In some lenses, the curved surfaces are replaced with flat surfaces, with a different angle in each section, Such a lens can be regarded as an array of prisms arranged in a circular fashion, with steeper prisms on the edges, and a flat or slightly convex center. Fresnel lens design allows a substantial reduction in thickness (and thus mass and volume of material), at the expense of reducing the imaging quality of the element.

The plurality of Fresnel lenses shown in FIG. 2 may be fabricated lithographically on a transparent surface such as a glass substrate. As a result, they may be precisely formed and positioned with respect to the sources 120.

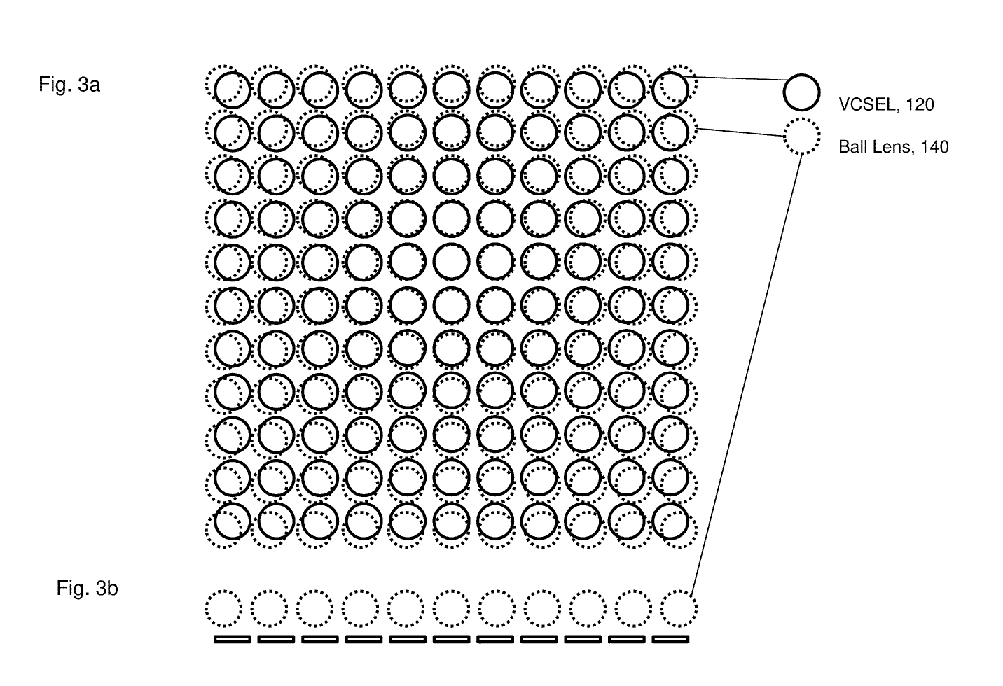

Another example of a beam shaping element 40 is a ball lens 140, a small, spherical transparent bead which may have a carefully crafted surface to optimize its optical characteristics. A ball lens 140 may act like other optical lenses, in that it may refract light and direct it to a focus or collimate diverging light. FIGS. 3a and 3b show the ball lens 140 embodiment in plan view and cross section. The optical axis of the microfabricated ball lenses 140 may be offset from the optical axis of the VCSEL. The amount of offset may be a function of the distance from the center of the array. The outermost rows and columns may have beam shaping elements that are offset most severely from the optical axis of the sources.

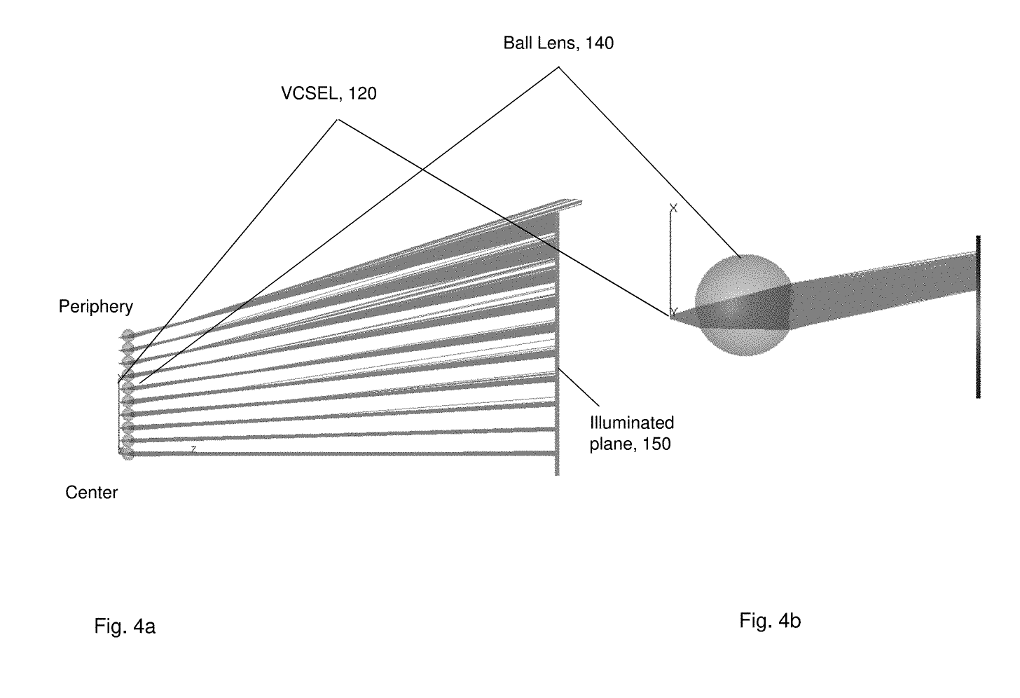

In one embodiment, the offset varies linearly with distance from the array center. For example, each beam shaping element may be offset by 1-2% of the distance from the array center. More generally, the maximum offset would be less than about 10% and more preferably around 2%. As a result, the outer periphery of the arrays handle generally more divergent light than the portions closer to center. FIG. 4a is labelled “center” and “periphery” to indicated which elements emit radiation that passes through essentially unchanged (center) and which elements undergo significant refraction (periphery). These peripheral elements may be subject to optical aberration, which can be addressed as described below.

Some details of one embodiment of such a device are set forth below:

Diam = 300 um, Pitch = 300 um, n = 10
Max offset = 60 um
Detector at: 10 mm from source
Last spot offset D = 5.2 mm
BK7 glass ball lens

| ball number | source offset mm | spot offset mm | degrees |
|---|---|---|---|
| 1 | 0 | 0 | |
| 2 | 0.0075 | | |
| 3 | 0.015 | | |
| 4 | 0.0225 | | |
| 5 | 0.03 | | |
| 6 | 0.0375 | | |
| 7 | 0.045 | | |
| 8 | 0.0525 | | |
| 9 | 0.06 | | |
| 10 | 0.0675 | 35 | 18 |

As mentioned, with the offset directly proportional to the distance from array center (such that the function is linear with respect to the distance from the center), the outermost rows and columns have beam shaping elements, here ball lenses, that are offset most severely from the optical axis of the sources. This effect is illustrated in FIGS. 4a and 4b.

FIG. 4a, 4b illustrates the effect of this proportionally offset arrangement. Because of the off-axis offset of the lenses at the outer rows and columns, the beams from the outer rows and columns emanate at an angle that is not 90 degrees with respect to the plane of the light source array. Only those beams at the center of the array emanate at 90 degrees. The beams emanating from outer rows and columns diverge slightly more than those from center, but generally all beams are collimated, as compared to the original radiation pattern from each light source 20, 120. A systematic but slight offset of the lens along the axis of emission can refocus the image of the light source at infinity.

FIG. 4b illustrates the effect of having the optical axis of the light source 20, 120 offset from the optical axis of the beam shaping element 40, 140. With the light source 20, 120 located below the beam shaping element 40, 140, the spot illuminated in the far field will fall above the midpoint of the optical element 40, 140 by an amount which is proportional to the offset distance, and distance to the image plane. Accordingly, light sources located at the periphery of the array will emanate from the array on a path that is not normal to the plane of the array. The embodiments described below make use of this effect.

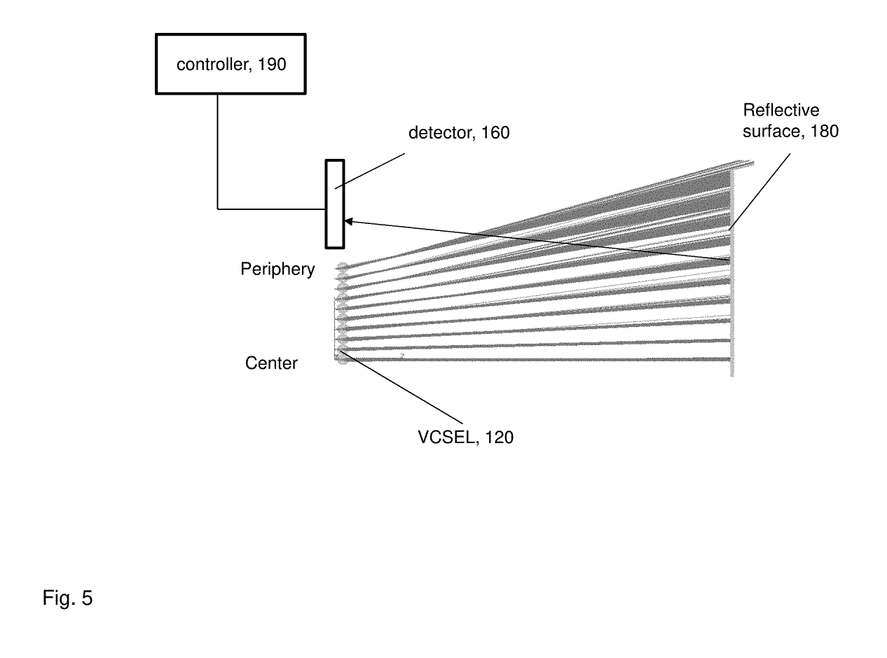

One application shown in FIG. 5 includes the provision of a detector 160 adjacent to the plurality of light sources 120. This detector 160 may detect reflected light when a reflective surface is positioned in the plane 180. The detector 160 may use discrete components, such as a single avalanche photodiode or it may use a CCD camera. As described briefly above, if the light from each VCSEL element is pulsed, the distance to the object can be determined by the timing of the optical reflection at the detector 160. That is, the elapse of time between the activation of each element 120 and the reception of reflected light from that element at the detector 160 is indicative of the range between the surface 180 and the emitter/detector 120/160. The detector 160 may be coupled to a controller 190 which generates an image of the reflective surface based on the measured delay times. Compared to a typical video frame duration of 16 msec, using this method offers an improvement of 1000×. This detector can employ an optical wavelength filter that passes only the wavelength of the VCSEL, thus great improving S/N. Therefore, the arrays may be used for a compact, robust radar-like device with no moving parts. Such systems, known as LIDAR for Light Detection And Ranging (sometimes Light Imaging, Detection, And Ranging may be more precise than RF based RADAR. In this embodiment, the detector may be housed in the same package as the VCSEL and Lens arrays.

As was done in FIG. 4a, FIG. 5 is labelled “center” and “periphery” to indicated which elements emit radiation that passes through essentially unchanged (center) and which elements undergo significant refraction (periphery). These peripheral elements may be subject to optical aberration, which can be addressed as described below.

In some embodiments, the light source may be pulsed for 10 nsec. The controller may then monitor the detector receiving the reflected signal within about a 1 microsecond window. In some embodiments wherein a compact structure is needed, the detector may be located as close as about 0.5 mm away from the arrays. In some embodiments, the maximum offset between the source and the beam shaping element may be as large as a ball diameter, or about 500 microns.

Modulation methods, such as frequency modulation, can also be applied to improve depth resolution and enhance velocity sensing. There are several other emerging LIDAR implementation and virtually all of them can employ the VCSEL/Lens array system described here.

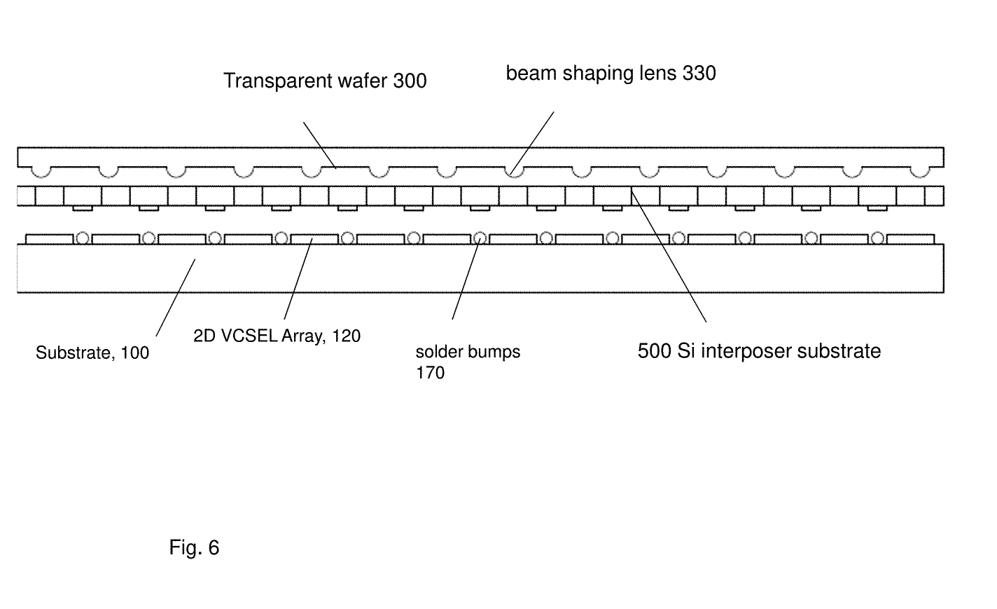

FIG. 6 is a cross sectional diagram of another embodiment of the scanning optical beam source. In this embodiment, the beam shaping elements 40 may be a lithographically contoured surface or lens 330 of a refractive material of transparent substrate 300. The material may be glass or fused silica or silicon dioxide or silicon for example. As before, the surface of a substrate 100 may be equipped with a plurality of light sources 120 which are formed in registration with apertures 505 formed in an interposer wafer 500. The interposer wafer 500 may be a silicon interposer wafer with etched through hole array and 1 or 2 metal routing layers. These metal layers may be used to power and/or address the individual VCSELs.

The interposer wafer 300 may support the microlens array 330 and transparent substrate 300 as shown, wherein the optical axis of each lens 330 is offset from the optical axis of the sources 120.

In some embodiments, the beam shaping lens 330 such as shown in FIG. 6, may be made using grey scale lithography. The term “grey scale lithography” refers to a method for making a contoured surface using photolithographic methods on a silicon substrate, as described briefly below.

The beam shaping lenses 330 may be formed using grey scale lithography on a transparent substrate 300, by making use of a thick photoresist. “Thick resists” means, that the resist film thickness is much higher than the penetration depth of the exposure light. For standard positive resists and standard exposure wavelengths (g-, h-, i-line), this means a thickness of >5 μm. (Of course, if small wavelengths with a very low penetration depth such as 310 nm are used, even a 1 μm resist film will be “thick” in this context). Under these conditions, the resist film cannot be completely exposed towards the bulk of the substrate.

However, the resist may be bleached in the process as follows: In the beginning of the exposure, light only penetrates the upper 1-2 μm of the resist film. This part of the resist film bleaches, so with the exposure going on, light will be able to penetrate the first 2-3 μm of the film, and so on. As a consequence, the exposed (and developable) resist film thickness goes approx. linear with the exposure dose. The transition exposed/unexposed is sufficiently sharp for reproducible greyscale lithography applications.

When the grayscale exposed resist is used in an etching process such as the one used to make lens 330, the thin areas of the grayscale resist are removed early on, leading to relatively deeply etched features. The thicker areas of resist persist through the etching step, leading to shallowly etched features. Accordingly, the dome-shaped lens 330 is produced by having thin portions of the grayscale resist cover the horizontal surface of the substrate, and the thickest areas over the top of the dome of the lens 330.

Grayscale lithography may be used to form a lens 330 on the surface of the transparent wafer 300. A plurality of lenses 330 is shown on the surface in FIG. 6. Accordingly, the scanning optical beam source may include a plurality of beam shaping elements 330 which are formed in a transparent substrate 300, using grey scale lithography.

As is well known from optics, a ray passing through a lens from a single point source which makes only a small angle with the optical axis will be focused at a point in the image plane of a perfectly spherical lens. However, rays which make a large angle with respect to the optical axis, may be focused at a slightly different spot because of aberration.

More specifically, rays of light proceeding from any object point unite in an image point; and therefore the object space is reproduced in an image space. However, this, is only true so long as the angles made by all rays with the optical axis (the symmetrical axis of the system) are infinitely small, However in systems where the angle is large, as is the case here, aberration may occur and the focal spot may become ill-defined or blurred. The ray may intersect the optical axis at a point nearer to the lens (longitudinal aberration) and/or off axis in the image plane (Lateral aberration)

Using grey scale lithography to form the lenses, this effect can be cancelled or corrected for, by making the lens shape slightly different for each lens. Lenses at the periphery of the array would have a slightly different shape (non-spherical) than lenses near the array center. As each lens may be microfabricated as described above. The solution may be to use gray-scale lithography to correct for this aberration.

The substrate with light sources 10, 100 may be held a distance away from the beam shaping lenses 330 by a interposer substrate, which serves as a standoff between the sources 120 and the lenses 330. The source wafer 10, 100 may be bonded to the interposer wafer 500 using a solder bond from solder bumps 170 formed adjacent to the devices. The interposer substrate 500 may have plurality of apertures formed therein, which are registered with the sources 120 and allow the light to pass through.

A method for fabrication of the devices shown in FIGS. 1-7 may be generally as follows. First, fabricate a plurality of microfabricated light sources disposed in a first array having an array center. Next, fabricate a plurality of microfabricated beam shaping elements disposed in a second array on a second substrate, the plurality of lenses having the same array center, wherein the microfabricated beam shaping elements are registered with the microfabricated light sources but have an optical center that is offset from the optical center of the light source by an amount which is a function of the distance from a center of the arrays.

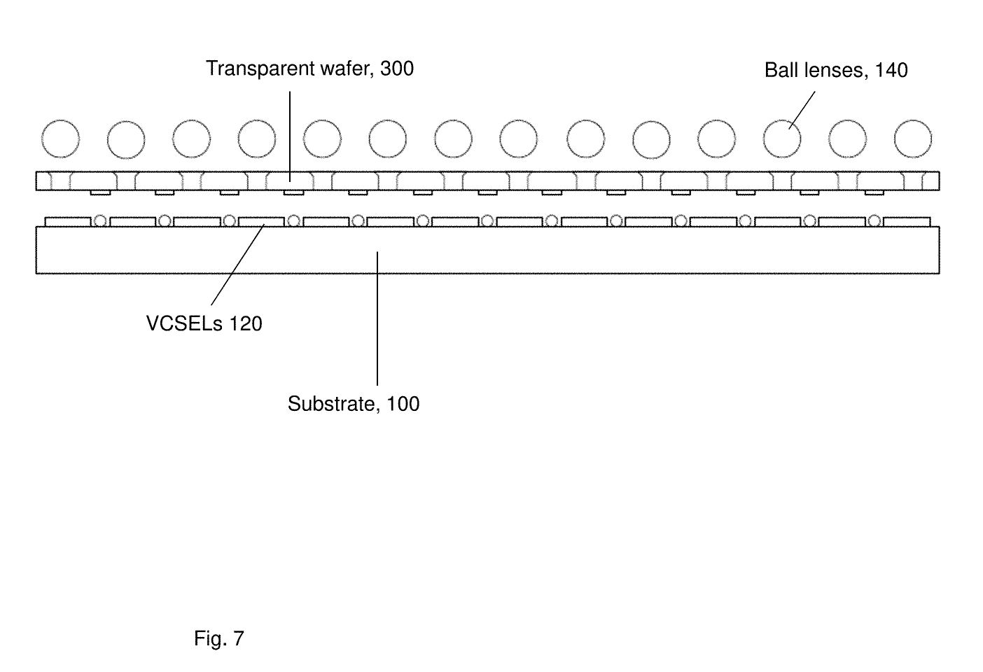

However, a more detailed process flow for these steps is given below for the devices shown in FIGS. 6 and 7. The device shown in FIG. 6 may be fabricated as follows:

Semiconductor Wafer 10, 100

1. Procure VCSEL wafer with light sources 20, 120 from III-V fab

2. Apply solder bumps (AuSn) 170

Interposer Wafer 500 (Si)

3. Deposit, pattern, and etch metal 1

4. Deposit, pattern and etch insulator layer

5. Deposit, pattern and etch metal 2

6. Deposit, pattern and etch solder mask

7. Pattern and etch through hole array 505

Beam shaping wafer 300 (SiO2)

8. Pattern, etch gray-scale lens array

9. Anti-reflection coat both sides

Back end processing

10. Align and reflow solder to bond wafers 100 and 500

11. Apply UV curable epoxy to the flat lands of the lens array wafer 300

12. Align and bond wafer 300 to wafers 100 and 500

13. Dice

FIG. 7 is a cross sectional diagram of another embodiment of the scanning optical beam source. In this embodiment, the beam shaping elements 40 may be a ball lens 140. As before, the surface of a substrate 100 may be equipped with a plurality of light sources 120 which are formed in registration with apertures formed in interposer wafer 500. The interposer wafer 500 may also have etched regions to seat the ball lenses. These regions may seat the ball lenses such that the optical axis of the ball lens is offset from the optical axis of the light source. This silicon interposer wafer 500 with KOH etched holes meeting DRIE holes and 1 or 2 metal routing layers is shown in FIG. 7

The embodiment shown in FIG. 7 may be fabricated as follows.

Semiconductor Wafer 100

1. Procure VCSEL wafer from III-V fab

2. Apply solder bumps (AuSn)

Beam shaping substrate 300 (<100> Si)

3. Deposit, pattern, and etch metal 1

4. Deposit, pattern and etch insulator layer

5. Deposit, pattern and etch metal 2

6. Deposit, pattern and etch solder mask

7. Pattern and KOH etch hole array half way

8. Pattern and DRIE hole array from backside

Back end processing

9. Align and reflow solder to bond Wafers 1 and 2

10. Apply UV curable epoxy to KOH facets

11. Place ball lenses and UV cure

12. Dice

The details involved in these process steps are known to those skilled in the art. Accordingly, further details are not provided here.

Accordingly, disclosed here is a scanning optical beam source, which may include a plurality of microfabricated light sources disposed in a first array having an array center and disposed on a first substrate, a plurality of microfabricated beam shaping elements disposed in a second array disposed on a second substrate having the same array center, wherein each microfabricated beam shaping element is registered with a microfabricated light source but has an optical axis that is offset from the optical axis of the light source by a different amount, which is a function the distance from a center of the arrays. The microfabricated light source is at least one of a VCSEL, an edge-emitting semiconductor laser, and super-luminescent LEDs. The microfabricated lenses comprise at least one of a ball lens, a diffraction grating, a refractive surface of a material with a different refractive index, and a Fresnel lens. The lenses may be offset by an amount less than about 10% and more preferably around 2% of their distance from the array center. The array may include a set of horizontal rows and vertical columns, and there are about 10 to about 100 light sources in each row and column.

The plurality of light sources is addressed individually, such that the radiation beam from the entire array illuminates an enlarged field of view in the far field. The light sources may be pulsed. The pulsed radiation is reflected from a reflective surface in a far field.

The axial position of the lens may be shifted slightly toward the light source in proportion to the distance of the from the center of the array to compensate for the shift in the object plane as the source is moved off axis.

The scanning optical beam source may also comprise a detector that detects reflected light from the plurality of pulsed light sources and a wavelength filter, wherein the wavelength filter passes only wavelengths of the light sources. The source may further comprise a modulator that modulates the frequency of the radiation to improve depth resolution and enhance velocity sensing, and a controller which is configured to pulse the plurality of light sources serially, and measures the elapsed time from the pulse to the detection of the reflected radiation. The controller may be configured to pulse the plurality of light sources serially, and measures the elapsed time from the pulse to the detection of the reflected radiation. The controller may also generate an image showing the locations of the reflective surfaces relative to one another and relative to the array center.

A method of fabricating an electronically steerable light source is also disclosed. The method may include fabricating a plurality of microfabricated light sources disposed in a first array having an array center, fabricating a plurality of microfabricated beam shaping elements disposed in a second array on a second substrate, the plurality of lenses having the same array center, wherein the microfabricated beam shaping elements are registered with the microfabricated light sources but have an optical center that is offset from the optical center of the light source by an amount which is proportional to the distance from a center of the arrays.

The microfabricated light source may be at least one of a VCSEL, an edge-emitting semiconductor laser, and super-luminescent LEDs. The mcrofabricated lenses may comprise at least one of a ball lens, a diffraction grating, a refractive surface of a material with a different refractive index, and a Fresnel lens.

The method may include energizing the plurality of light sources sequentially across each row and sequentially down each column, so that an image cast by the plurality of microfabricated sources is raster scanned. The method may further include emitting radiation from at least one of the plurality of light sources, reflecting the radiation from at least one of the plurality of light sources on a reflective surface, detecting the reflected light with a detector, measuring the time elapsed from emission to detection. The method may include forming an image of the reflective surface and its distance from the plurality of light sources using elapsed time measurements. The image may be a LIDAR image that displays the locations of the reflective surfaces relative to one another and relative to the array center.

While various details have been described in conjunction with the exemplary implementations outlined above, various alternatives, modifications, variations, improvements, and/or substantial equivalents, whether known or that are or may be presently unforeseen, may become apparent upon reviewing the foregoing disclosure. Accordingly, the exemplary implementations set forth above, are intended to be illustrative, not limiting.

What is claimed is:

1. An scanning optical beam source, comprising:
a plurality of microfabricated light sources disposed in a first array having an array center and disposed on a first substrate;
a plurality of microfabricated beam shaping elements disposed in a second array disposed on a second substrate having the same array center, wherein each microfabricated beam shaping element is registered with a microfabricated light source but has an optical axis that is offset from the optical axis of the light source by a different amount, wherein the amount is a function of the distance from a center of the arrays.

2. The scanning optical beam source of claim 1, wherein the microfabricated light source is at least one of a VCSEL, an edge-emitting semiconductor laser, and super-luminescent LEDs, and the function is at least one of linear, quadratic, hyperbolic and exponential.

3. The scanning optical beam source of claim 1, wherein the microfabricated beam shaping elements comprise at least one of a ball lens, a refractive surface of a material with a different refractive index, and a Fresnel lens.

4. The scanning optical beam source of claim 1, wherein the lenses are offset by an amount equal to about 10% of their distance from the array center.

5. The scanning optical beam source of claim 1, wherein the lenses are offset by an amount equal to or less than about 10% of their distance from the array center.

6. The scanning optical beam source of claim 1, wherein the array comprises a set of horizontal rows and vertical columns, and there are about 10 to about 100 light sources in each row and column.

7. The scanning optical beam source of claim 1, wherein the plurality of light sources is addressed individually, such that the radiation beam from the entire array illuminates an enlarged field of view in the far field.

8. The scanning optical beam source of claim 1, wherein the light sources are pulsed.

9. The scanning optical beam source of claim 8, wherein the pulsed radiation is reflected from a reflective surface in a far field.

10. The scanning optical beam source of claim 9, further comprising:
a detector that detects reflected light from the plurality of pulsed light sources; and
a wavelength filter, wherein the wavelength filter passes only wavelengths of the light sources.

11. The scanning optical beam source of claim 1, further comprising a modulator that modulates the frequency of the radiation to improve depth resolution and enhance velocity sensing.

12. The scanning optical beam source of claim 9, further comprising:
a controller which is configured to pulse the plurality of light sources serially, and measures the elapsed time from the pulse to the detection of the reflected radiation.

13. The scanning optical beam source of claim 12, wherein the controller also generates an image showing the locations of the reflective surfaces relative to one another and relative to the array center.

14. The scanning optical beam source of claim 1 wherein the axial position of the lens is shifted slightly toward the light source in proportion to the distance of the from the center of the array to compensate for a shift in the object plane as the source is moved off axis.

15. The scanning optical beam source of claim 1 wherein the focal length of the beam shaping element is slightly increased in proportion to the distance of the from the center of the array to compensate for a shift in the object plane as the source is moved off axis.

16. The scanning optical beam source of claim 1, wherein the function is at least of linearly varying, quadratically varying, hyperbolically varying and exponentially varying.

17. The scanning optical beam source of claim 1, wherein the microfabricated beam shaping elements in a periphery of the second array have a different shape than microfabricated beam shaping elements at a center of the array.

18. A method of fabricating an electronically steerable light source, comprising:
fabricating a plurality of microfabricated light sources disposed in a first array having an array center;
fabricating a plurality of microfabricated beam shaping elements disposed in a second array on a second substrate, the plurality of lenses having the same array center, wherein the microfabricated beam shaping elements are registered with the microfabricated light sources but have an optical center that is offset from the optical center of the light source by an amount which is a function of the distance from a center of the arrays.

19. The method of fabricating an electronically steerable light source of claim 18, wherein the microfabricated light source is at least one of a VCSEL, an edge-emitting semiconductor laser, and super-luminescent LEDs, and the function is at least one of linear, quadratic, hyperbolic and exponential.

20. The method of fabricating an electronically steerable light source of claim 18, wherein the microfabricated beam shaping elements comprise at least one of a ball lens, a diffraction grating, a refractive surface of a material with a different refractive index, and a Fresnel lens.

21. The method of using the electronically steerable light source of claim 18, comprising;
energizing the plurality of light sources sequentially across each row and sequentially down each column, so that an image cast by the plurality of microfabricated sources is raster scanned.

22. The method of using the scanning optical beam source of claim 18, comprising:
emitting radiation from at least one of the plurality of light sources;
reflecting the radiation from at least one of the plurality of light sources on a reflective surface;
detecting the reflected light with a detector;
measuring the time elapsed from emission to detection.

23. The method of using the scanning optical beam source of claim 18, further comprising:
forming an image of the reflective surface and its distance from the plurality of light sources using elapsed time measurements.

24. The method of using the scanning optical beam source of claim 18, wherein the image is a LIDAR image that displays the locations of the reflective surfaces relative to one another and relative to the array center.

25. A method of fabricating an electronically steerable light source of claim 18, wherein the beam shaping elements are formed by gray scale lithography.
